(19) United States
(12) Patent Application Publication
(10) Pub. No.: US 2007/0279655 A1
(43) Pub. Date: Dec. 6, 2007

(54) Image processing apparatus, processing method for setting and storage medium

(75) Inventor: Akira Murakawa, Toyonaka-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/591,514

(22) Filed: Nov. 2, 2006

(30) Foreign Application Priority Data
Jun. 6, 2006 (JP) 2006-157441

(51) Int. Cl. G06F 15/00

(52) U.S. Cl. 358/1.9

(57) ABSTRACT

An image processing apparatus includes a communications portion for communicating with a plurality of other image processing apparatuses via a communications line, an apparatus attribute information obtaining portion for obtaining attribute information indicating attributes of the respective other image processing apparatuses via the communications line, suitable setting information-containing apparatus determination portion for determining, among setting information indicating setting details of the respective other image processing apparatuses, the setting information suitable for the image processing apparatus itself based on the obtained second apparatus attribute information, an apparatus setting information obtaining portion for obtaining the second apparatus setting information determined to be suitable, and an apparatus setting information registration portion for using all or some of the setting details indicated in the obtained second apparatus setting information.

This application is based on Japanese patent application No. 2006-157441 filed on Jun. 6, 2006, the contents of which are hereby incorporated by reference.

### BACKGROUND OF THE INVENTION

1. Field of the Invention

The present invention relates to an image processing apparatus such as an MFP used in a computer network and to a processing method for setting for the image processing apparatus.

2. Description of the Related Art

Image processing apparatuses called multifunction devices or Multi Function Peripherals (MFPs) have recently come into widespread use. The image processing apparatuses have various functions including a copy function, a network printing function, a scanner function, a fax function and a document server function. The image processing apparatuses will probably become more multifunctional from now on.

As the number of functions increases, more settings become necessary upon introducing an image processing apparatus. This imposes a heavy burden on a worker who performs a task for the settings.

There is proposed a method described in Japanese unexamined patent publication No. 11-161441. According to the method, a printer is configured to perform the following processing. When detecting a master device to be the update source of set information required for executing a job, a printer receives the set information from the master device via a network and stores the set information. When the printer having such a configuration is used, only by setting the first printer connected to the network as the master device, initial setting can be automatically performed, concerning the printer after the second printer, only by connecting it to the network and turning on a power source. Accordingly, a load required for installation can be saved.

Meanwhile, setting information of plural image processing apparatuses that are present in the same network indicates setting details different from one another. Thus, for the purpose of an appropriate task for setting of an image processing apparatus that is newly added to the network, it is necessary to select properly which of setting information of the existing image processing apparatuses is used. Stated differently, it is important to select which of the existing image processing apparatuses is used as a master apparatus.

In the method described in Japanese unexamined patent publication No. 11-161441, however, a suitable master apparatus cannot be selected from among the existing image processing apparatuses. Thus, it is impossible to select the existing setting information suitable for a new image processing apparatus to use the selected setting information for setting of the new image processing apparatus.

### SUMMARY OF THE INVENTION

The present invention is directed to solve the problems pointed out above, and therefore, an object of the present invention is to properly select setting information suitable for a new image processing apparatus from among setting information of the existing image processing apparatuses, so that the selected setting information becomes available for setting for the new image processing apparatus.

According to one aspect of the present invention, an image processing apparatus performs processing relating to an image. The apparatus includes a communications portion for communicating with a plurality of other image processing apparatuses via a communications line, an attribute information obtaining portion for obtaining attribute information via the communications line, the attribute information indicating an attribute of each of the other image processing apparatuses, a determination portion for determining, among setting information indicating setting details of each of the other image processing apparatuses, the setting information suitable for the image processing apparatus itself based on the attribute information obtained by the attribute information obtaining portion, a setting information obtaining portion for obtaining the setting information that is determined to be suitable by the determination portion from the other image processing apparatus having the setting information via the communications line, and a setting processing portion for using all or some of the setting details indicated in the setting information for setting of the image processing apparatus itself, the setting information being obtained by the setting information obtaining portion.

Preferably, the attribute information of the other image processing apparatus indicates a type of the other image processing apparatus, and the determination portion determines that the setting information of the other image processing apparatus whose type is closest to a type of the image processing apparatus itself is suitable.

Further, the attribute information of the other image processing apparatus indicates a function included in the other image processing apparatus, and the determination portion determines that the setting information of the other image processing apparatus having the function whose configuration is closest to a configuration of a function included in the image processing apparatus itself is suitable.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of the entire configuration of an image processing system.

FIG. 2 is a diagram showing an example of a hardware configuration of an image forming apparatus.

FIG. 3 is a diagram showing an example of a functional configuration of the image forming apparatus.

FIG. 4 shows an example of attribute information.

FIG. 5 shows an example of setting information.

FIG. 6A shows an example of a list of types of the image forming apparatuses and FIG. 6B shows an example of grouping of the types.

FIG. 7 shows an example of a selection screen.

FIG. 8 is a flowchart showing an example of the entire processing flow of the image forming apparatus that newly joins the image processing system.

FIG. 9 is a flowchart showing a modification of the entire processing flow of the image forming apparatus that newly joins the image processing system.

FIG. 10 shows an example of a function importance level table.

FIG. 11 shows an example of a function importance level table.

FIG. 12 shows an example of a selection screen.

### DESCRIPTION OF THE PREFERRED EMBODIMENTS

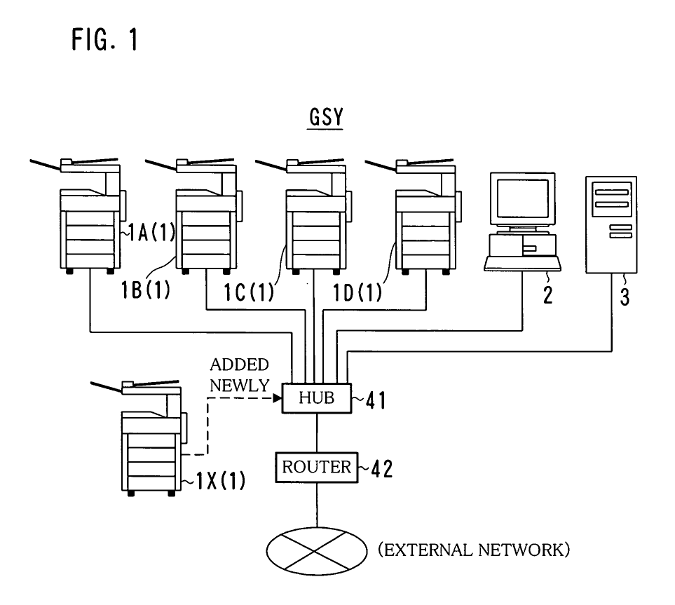

Referring to FIGS. 1, 2 and 3, an example of the entire configuration of an image processing system GSY, an example of a hardware configuration of an image forming apparatus 1 and an example of a functional configuration of the image forming apparatus 1 will be described.

Referring to FIG. 1, the image processing system GSY includes plural image forming apparatuses 1 according to the present invention, one or more terminals 2, a Dynamic Host Configuration Protocol (DHCP) server 3, a hub 41 and a router 42. Each of the image forming apparatuses 1, each of the terminals 2, the DHCP server 3 and the router 42 can be interconnected via the hub 41 and a communications line. Further, each of the image forming apparatuses 1 and each of the terminals 2 can be connected via the router 42 to a device, e.g., a Web server or a mail server on the Internet, outside the image processing system GSY. Hereinafter, each of the image forming apparatuses 1 is sometimes referred to as an “image forming apparatus 1A”, an “image forming apparatus 1B”, an “image forming apparatus 1C” . . . in order to distinguish the image forming apparatuses 1 from one another.

The image forming apparatuses 1 are image processing apparatuses in which various functions such as a copy function, a scanner function, a FAX function, a network printing function, a document server function and a file transfer function are integrated. The image forming apparatuses 1 are sometimes called multifunction devices or Multi Function Peripherals (MFPs). Note that the image forming apparatuses 1 do not necessarily have all these functions.

Each of the image forming apparatuses 1 is installed in a government or corporate office, a public facility such as a school or a library and other various places. The image forming apparatus 1 can be shared by plural users.

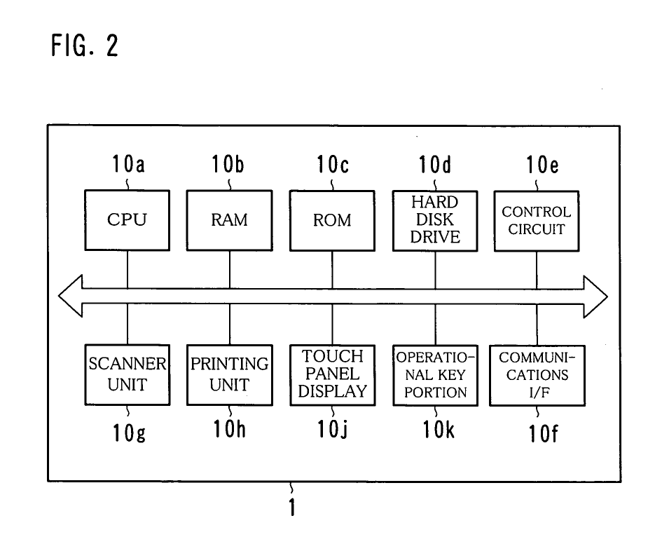

As shown in FIG. 2, the image forming apparatus 1 includes a CPU 10a, a RAM 10b, a ROM 10c, a hard disk drive 10d, a control circuit 10e, a communications interface 10f, a scanner unit 10g, a printing unit 10h, a touch panel display 10j and a operational key portion 10k.

The control circuit 10e is a circuit for controlling the hard disk drive 10d, the communications interface 10f, the scanner unit 10g, the printing unit 10h, the touch panel display 10j and the operational key portion 10k.

The communications interface 10f is a modem for performing data communications with a fax terminal outside the image processing system GSY using a FAX protocol such as G3 and is a Network Interface Card (NIC) for performing so-called IP communications with other image forming apparatus 1 using TCP/IP and the like.

The operational key portion 10k is made up of, for example, a numeric keypad and a cursor key, and is used by a user to provide commands, such as a command to start execution of processing, to the image forming apparatus 1 and to specify processing conditions and various other matters. The touch panel display 10j displays a screen for providing the user with messages or instructions, a screen for the user to enter desired types of processing and processing conditions, a screen for registering setting details of each function, and a screen for indicating results of the processing executed in the CPU 10a, for example. In addition, the user can provide commands to the image forming apparatus 1, specify processing conditions, or register setting information by touching predetermined positions on the touch panel display 10j. Thus, the touch panel display 10j and the operational key portion 10k serve as user interfaces for the user operating the image forming apparatus 1.

The scanner unit 10g optically reads document images such as text, numerical expressions, symbols, photographs, diagrams or illustrations that are depicted on a sheet of paper, and generates image data.

The printing unit 10h forms an image based on the image data obtained with the scanner unit 10g or image data transmitted from the terminal 2 or others, and prints the image on a sheet of paper.

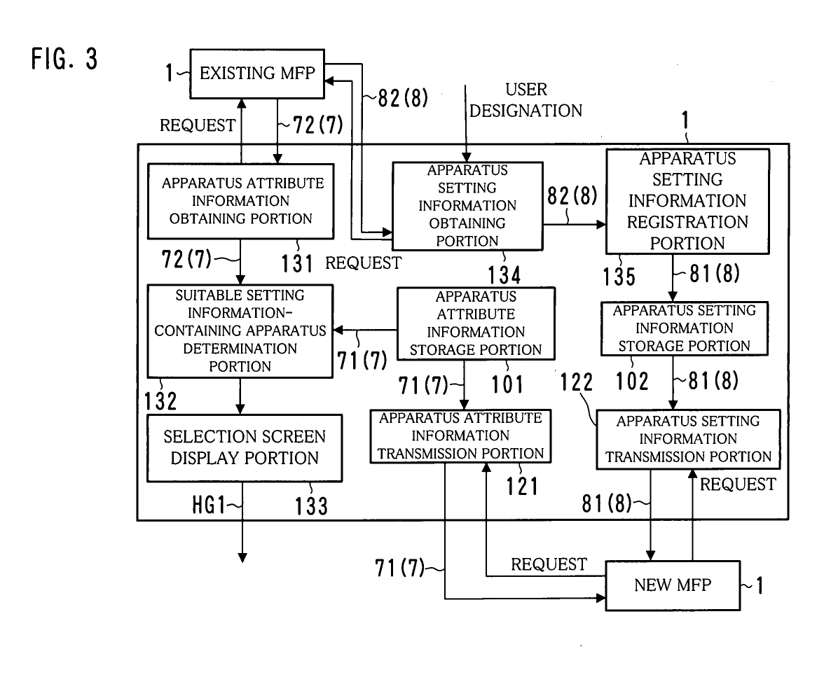

As shown in FIG. 3, on the hard disk drive 10d are stored a program and data for implementing functions of an apparatus attribute information storage portion 101, an apparatus setting information storage portion 102, an apparatus attribute information transmission portion 121, an apparatus setting information transmission portion 122, an apparatus attribute information obtaining portion 131, a suitable setting information-containing apparatus determination portion 132, a selection screen display portion 133, an apparatus setting information obtaining portion 134 and an apparatus setting information registration portion 135. The program and data are read into the RAM 10b as needed, and the program is executed by the CPU 10a. Alternatively, some or all of the functions shown in FIG. 3 may be implemented with the control circuit 10e.

A personal computer, a workstation or the like is used as the terminal 2. On the terminal 2 is installed a driver and an application corresponding to each of the image forming apparatuses 1. A user can operate the terminal 2 to let the image forming apparatus 1 desired by him/her perform processing including printing, scanning, FAX data transmission and network printing (so-called PC printing). In addition, the user can also register setting details of the image forming apparatus 1 by operating the terminal 2.

Each of the image forming apparatuses 1 and each of the terminals 2 are fixedly given a unique device name and a unique MAC address to distinguish the image forming apparatuses 1 and the terminals 2 from one another. Further, the DHCP server 3 dynamically assigns a unique IP address to each of the image forming apparatuses 1 and each of the terminals 2.

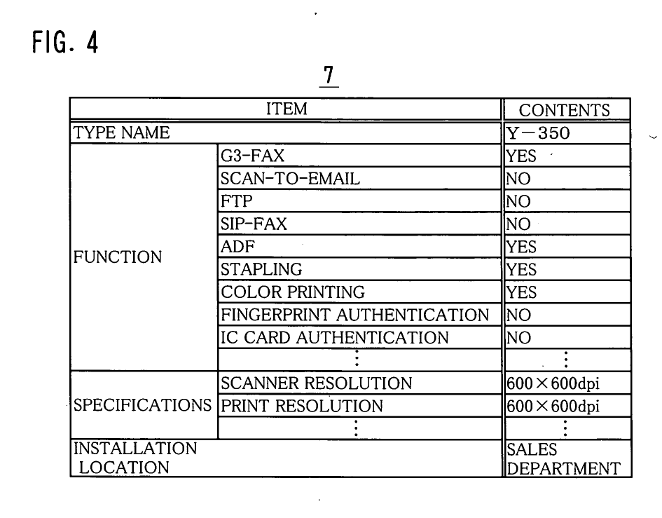

Referring to FIGS. 4, 5, 6A and 6B and 7, an example of attribute information 7, an example of setting information 8, an example of a list of types of the image forming apparatuses 1, and example of grouping of the types and an example of a selection screen HG1 will be described. The following are detailed descriptions of processing details of each of the portions included in the image forming apparatus 1 shown in FIG. 3.

Referring to FIG. 4, the apparatus attribute information storage portion 101 stores the attribute information 7 on attributes such as a type name, functions, specifications and an installation location of the image forming apparatus 1 itself.

The attribute information 7 is stored in the apparatus attribute information storage portion 101 upon shipment. A part of the contents of the attribute information 7 is changed during operation as the need arises. For example, the type name is determined in advance and is not changed. In contrast, information on functions and specifications are changed appropriately every time when a configuration of the image forming apparatus 1 is changed by adding or deleting optional hardware or software.

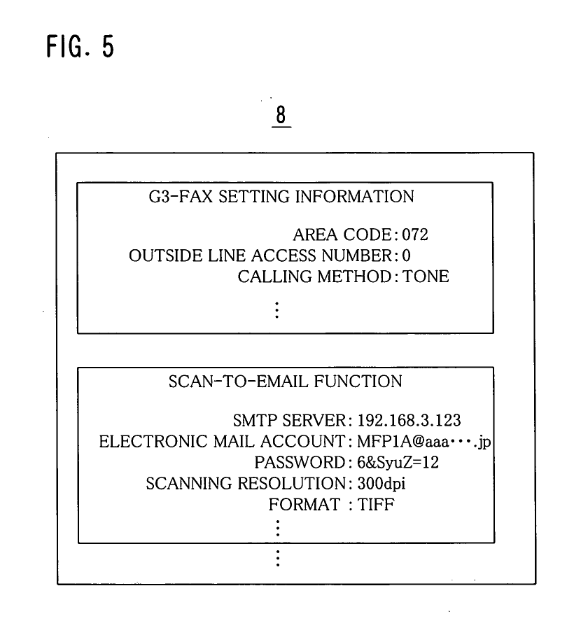

Referring to FIG. 5, the apparatus setting information storage portion 102 stores the setting information 8 indicating setting details of a function included in the image forming apparatus 1 itself as a default and of a function added as an option.

In the case where, for example, the image forming apparatus 1 includes a FAX communications function using a G3 protocol (hereinafter referred to as a “G3-FAX function”), the setting information 8 indicates setting details such as an area code, an outside line access number and a calling method of a telephone line connected to the communications interface 10f.

In the case where the image forming apparatus 1 includes a function of attaching image data obtained by scan processing with the scanner unit 10g to an electronic mail to transmit the electronic mail (hereinafter referred to as a “SCAN-TO-EMAIL function”), the setting information 8 indicates setting details such as a Simple Mail Transfer Protocol (SMTP) server used for the transmission of the electronic mail, an electronic mail account, a password, a scanning resolution of a document and an image data format.

In the case where the image forming apparatus 1 includes a function of managing an address book for a FAX number or an electronic mail address (hereinafter referred to as an “address book function”), the setting information 8 indicates setting details such as data for the FAX number or the electronic mail address and a display format of the data, e.g., a list format or a card format.

In the case where the image forming apparatus 1 includes a function of performing user authentication or sector authentication using a biometrics technology such as fingerprint authentication (hereinafter referred to as a “biometrics function”), the setting information 8 indicates physical characteristics data, e.g., fingerprint data, for each user. When the image forming apparatus 1 includes a function of performing user authentication or sector authentication using an IC card (hereinafter referred to as an “IC card authentication function”), the setting information 8 indicates an ID for each user. Note that the “sector authentication” means an authentication process in which an account (a so-called group account) corresponding to a user account is given to each sector such as a division, a department or a section of an organization using the image processing system GSY and an authentication process is performed based on the group account upon logging in or accessing a resource.

Other than those above, setting details of the following functions are indicated depending on the presence or absence of each of the functions: a function of stapling a printed material (a stapling function), a function of feeding document paper to the scanner unit 10g with an Auto Document Feeder (ADF) (an ADF function), a function of transferring a file using a File Transfer Protocol (FTP) (an FTP function), a function of sending and receiving FAX data using a Session Initiation Protocol (SIP) (an SIP-FAX function), a function of performing a user authentication process (a user authentication function), and a function of performing a sector authentication process (a sector authentication function).

Before the image forming apparatus 1 itself is installed in the image processing system GSY, the setting information 8 is not stored in the apparatus setting information storage portion 102. A method and timing of generating the setting information 8 will be described later.

In response to a request from the other image forming apparatus 1, the apparatus attribute information transmission portion 121 and the apparatus setting information transmission portion 122 serve to send the attribute information 7 and the setting information 8 of its own apparatus, respectively, to the other image forming apparatus 1.

The apparatus attribute information obtaining portion 131 through the apparatus setting information registration portion 135 perform processing for generating and using the setting information 8 of the image forming apparatus 1 itself when the image forming apparatus 1 itself is newly added to the image processing system GSY.

A user (hereinafter referred to as a “worker”) performing a task for adding the image forming apparatus 1 to the image processing system GSY performs predetermined operation. Then, the apparatus attribute information obtaining portion 131 searches for the other image forming apparatuses 1 present in the image processing system GSY to obtain the attribute information 7 of each of the other image forming apparatuses 1 thus searched. Hereinafter, the obtained attribute information 7 of the other image forming apparatus 1 is sometimes referred to as “second apparatus attribute information 72”. Additionally, the attribute information 7 of the image forming apparatus 1 itself is sometimes referred to as “first apparatus attribute information 71”.

The suitable setting information-containing apparatus determination portion 132 determines which of the setting information 8 of the other image forming apparatuses 1 is appropriate to be used in order to generate the setting information 8 for the image forming apparatus 1 itself. The determination is conducted based on each piece of the obtained second apparatus attribute information 72 and the first apparatus attribute information 71 stored in the apparatus attribute information storage portion 101. In short, the suitable setting information-containing apparatus determination portion 132 determines the other image forming apparatus 1 having the appropriate setting information 8. Hereinafter, the setting information 8 of the image forming apparatus 1 itself is sometimes referred to as “first apparatus setting information 81” and the setting information 8 of the other image forming apparatus 1 is sometimes referred to as “second apparatus setting information 82”.

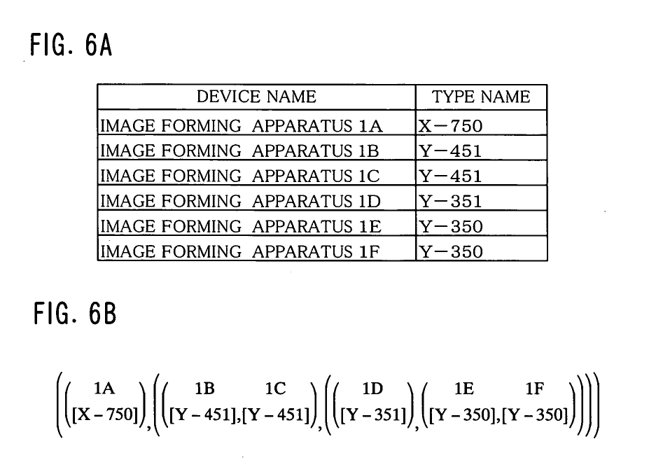

The suitable setting information-containing apparatus determination portion 132 performs the determination processing, for example, in the following manner based on type names specified in the first apparatus attribute information 71 and each piece of the second apparatus attribute information 72. Firstly, the image forming apparatuses 1 having the same type name are grouped. Secondly, groups having a similar type name are grouped. More specifically, a small group is made by the image forming apparatuses 1 having the same type name and a large group is made by similar groups. For example, in the case where the image forming apparatuses 1A-1F have type names as shown in FIG. 6A, groups are made in a manner shown in FIG. 6B.

A similar type name may be determined based on identification names of a series, a grade and a generation specified in a type name used when the image forming apparatus 1 is distributed as a product. In FIG. 6B, “X” in “X-750” and “Y” in “Y-451” and the like represent series. Further, “35” in “Y-351” and “45” in “Y-451” and the like represent levels of grade and “0” in “Y-450” and “1” in “Y-451” and the like represent generations.

Based on the grouped result, sorting is performed in order of the other image forming apparatuses 1 having a type name close to the type name indicated in the first apparatus attribute information 71, i.e., the type name of the image forming apparatus 1 itself. For example, when a suitable setting information-containing apparatus determination portion 132 of an image forming apparatus 1D performs sorting, image forming apparatuses 1E, 1F, 1B, 1C and 1A are ranked in this order. Note that the order of the image forming apparatuses 1E and 1F may be reversed or be the same because they have the same type name. The same applies to the image forming apparatuses 1B and 1C.

Further, the degree of similarity of the type names is determined. Such degree of similarity can be calculated based on the degree of the differences between the series, the grades or the generations specified in the type names. Suppose, for example, that the degree of similarity of the same type names is set to “100”. Stated differently, the maximum value of the degree of similarity is set to “100.”. Then, the following subtraction is performed from the maximum value to calculate the degree of similarity. When the series differ from each other, a predetermined value, e.g., “50” is subtracted. The greater the grade difference is, the larger predetermined value is subtracted. Alternatively, the greater the generation difference is, the larger predetermined value is subtracted.

The suitable setting information-containing apparatus determination portion 132 determines that the other image forming apparatuses 1 having the degree of similarity equal to or more than a predetermined degree include the appropriate setting information 8. In addition, the suitable setting information-containing apparatus determination portion 132 determines that as the other image forming apparatuses 1 have a higher rank after the sorting or have a higher degree of similarity to the image forming apparatus 1, such other image forming apparatuses 1 include the appropriate setting information 8.

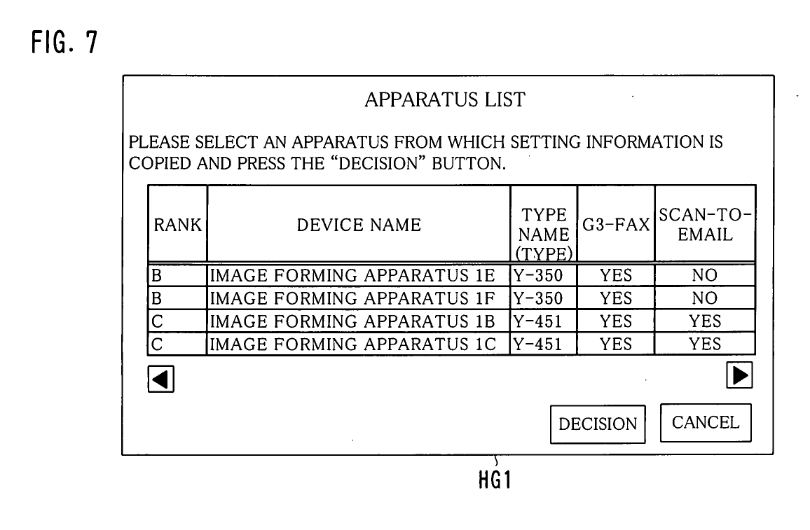

The selection screen display portion 133 displays, on the touch panel display 10j, the selection screen HG1 showing a list of the other image forming apparatuses 1 that are determined to have the suitable setting information 8 by the suitable setting information-containing apparatus determination portion 132. As shown in FIG. 7, the selection screen HG1 indicates device names, type names, functions, ranks and others of the other image forming apparatuses 1 in the order in which the other image forming apparatuses 1 are determined to have more suitable setting information 8. The functions can be known from the second apparatus attribute information 72 of the respective other image forming apparatuses 1. The rank shows a level (the degree of similarity) as to how close to the type name of the image forming apparatus 1 itself. When the other image forming apparatus 1 has the same type name as the image forming apparatus 1 itself, the other image forming apparatus 1 is ranked “A”. Subsequently, the other image forming apparatuses 1 are ranked “B”, “C”, “D”, . . . in descending order.

In the case where a worker uses the terminal 2 to perform operation remotely, data for displaying the selection screen HG1 is sent to the terminal 2. Responding to this, the terminal 2 displays the selection screen HG1 based on the data.

The worker selects, from the list of the selection screen HG1, the other image forming apparatus 1 having the setting information 8 (the second apparatus setting information 82) indicating setting details desirable for the image forming apparatus 1 on which the worker works, then to press a “decision” button.

Then, the apparatus setting information obtaining portion 134 requests the other image forming apparatus 1, which is selected by the worker, to send the setting information 8 for the other image forming apparatus 1 and receives (obtains) the same.

The apparatus setting information registration portion 135 performs processing for registering in the apparatus setting information storage portion 102 the setting information 8 for the image forming apparatus 1 itself, i.e., the first apparatus setting information 81, for example, in the following procedure.

Firstly, the apparatus setting information registration portion 135 creates blank first apparatus setting information 81. The apparatus setting information registration portion 135 extracts setting details relating to a function included in the image forming apparatus 1 itself from setting details of functions indicated in the second apparatus setting information 82 obtained by the apparatus setting information obtaining portion 134. The setting details thus extracted are written into the first apparatus setting information 81. Stated differently, the apparatus setting information registration portion 135 copies the setting details corresponding to the function of the image forming apparatus 1 from the second apparatus setting information 82, thereby to create the first apparatus setting information 81. Secondly, the apparatus setting information registration portion 135 makes the apparatus setting information storage portion 102 store the first apparatus setting information 81. Thus, the first apparatus setting information 81 is applied to the image forming apparatus 1 itself and is used for various processing to be executed later.

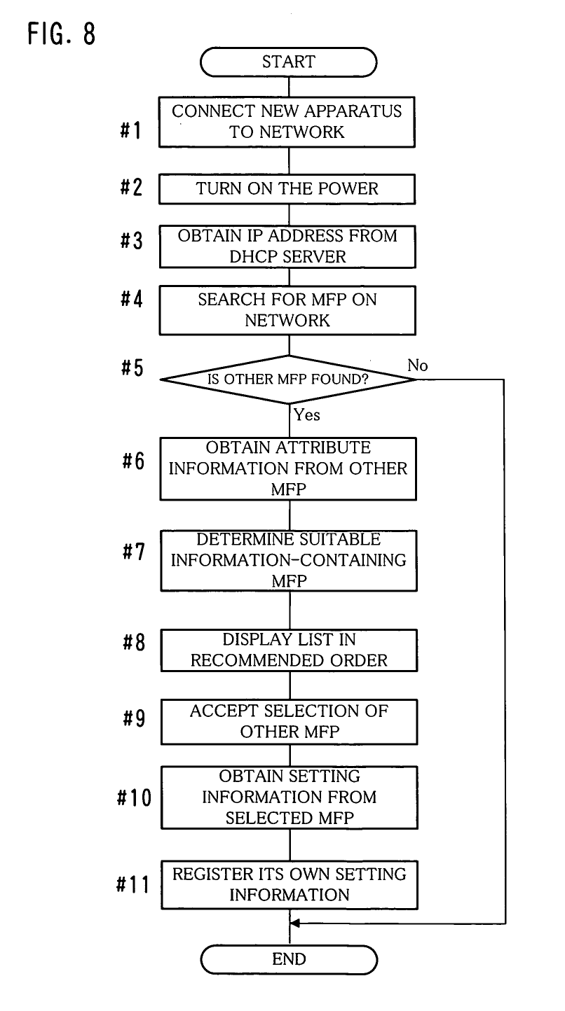

FIG. 8 is a flowchart showing an example of the entire processing flow of the image forming apparatus 1 that newly joins the image processing system GSY.

Next, descriptions are provided, with reference to the flowchart, of a processing flow of registering the setting information 8. The registration processing is performed when the image forming apparatus 1 is newly added to the image processing system GSY.

Suppose, for example, that the image forming apparatuses 1A-1D are operated in the image processing system GSY as shown in FIG. 1 and an image forming apparatus 1X is about to be newly added thereto.

Referring to FIG. 8, the image forming apparatus 1X is connected to the hub 41 via a LAN cable or the like and is turned on by a worker (#1 and #2).

The image forming apparatus 1X requests an IP address from the DHCP server 3, obtains the IP address and applies the same to the image forming apparatus 1X itself (#3). The image forming apparatus 1X searches for the other image forming apparatuses 1 already operating in the image processing system GSY (#4). In this case, four of the image forming apparatuses 1A-1D are found.

When finding the image forming apparatuses 1A-1D (Yes in #5), the image forming apparatus 1X requests the image forming apparatuses 1A-1D to send the respective attribute information 7 to obtain the same (the second apparatus attribute information 72) (#6). The image forming apparatus 1X determines, from the image forming apparatuses 1A-1D, an apparatus having the setting information 8 (the second apparatus setting information 82) indicating appropriate setting details for the image forming apparatus 1X. The determination is conducted based on type names indicated in the obtained second apparatus attribute information 72 of the image forming apparatuses 1A-1D and a type name indicated in the attribute information 7 for the image forming apparatus 1X itself, i.e., the first apparatus attribute information 71 (#7).

The image forming apparatus 1X displays the selection screen HG1 in which the device names and others of the image forming apparatuses 1A-1D are listed in descending order of high suitability of the second apparatus setting information 82 included in the image forming apparatuses 1A-LD (#8). In the case, however, where the worker uses the terminal 2 to perform operation, the selection screen HG1 is displayed on the terminal 2.

Here, the worker selects the other image forming apparatus 1 having the second apparatus setting information 82 used for registration of the first apparatus setting information 81. Then, the image forming apparatus 1X accepts the selection (#9) and requests the setting information 8 (the second apparatus setting information 82) from the other image forming apparatus 1, then to obtain the same (#10).

The image forming apparatus 1X prepares blank first apparatus setting information 81. The entire or a part of setting details indicated in the second apparatus setting information 82 thus obtained is written into the first apparatus setting information 81, so that the first apparatus setting information 81 is registered in the apparatus setting information storage portion 102 (#11).

The processing described above is performed to complete setting for the use of the image forming apparatus 1X in the image processing system GSY. As the need arises, it is possible to customize setting details of the first apparatus setting information 81 through the operation of the worker as before.

According to this embodiment, the image forming apparatus 1 that is newly added to the image processing system GSY selects and obtains the second apparatus setting information 82 suitable for the image forming apparatus 1 itself from the respective second apparatus setting information 82 of the other image forming apparatuses 1 that already join the image processing system GSY. Then, the newly-added image forming apparatus 1 performs processing of registering the first apparatus setting information 81 based on setting details indicated in the obtained second apparatus setting information 82. Thus, setting processing of the newly-added image forming apparatus 1 can be performed more adequately than before without bothering a worker who performs a task for the setting.

Further, plural pieces of the second apparatus setting information 82 with a predetermined suitability level or more are presented to the worker. Then, the worker selects the second apparatus setting information 82 to be used to perform the registration processing of the first apparatus setting information 81. Accordingly, the worker can perform setting operation securely.

In this embodiment, the descriptions are provided, by way of example, of the image forming apparatus 1 that is newly added to the image processing system GSY. The present invention can apply also to the case of resetting and reregistering setting details of the image forming apparatus 1 that already joins the image processing system GSY.

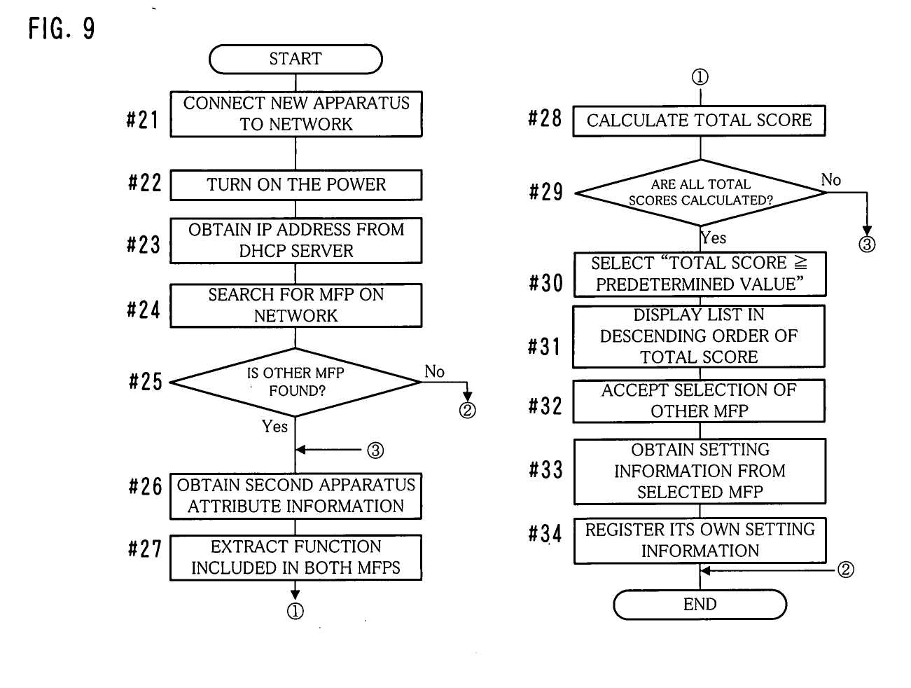

Referring to FIGS. 9, 10, 11 and 12, a modification of the entire processing flow of the image forming apparatus 1 that newly joins the image processing system GSY, an example of a function importance level table TL, an example of a function importance level table TL′ and an example of a selection screen HG2 will be described.

In this embodiment, as described earlier with reference to FIG. 6, the image forming apparatus 1 determines which of the second apparatus setting information 82 included in the other image forming apparatuses 1 can be appropriate to be used when the first apparatus setting information 81 is registered. Instead, the determination may be performed based on respective functions indicated in the first apparatus attribute information 71 and the second apparatus attribute information 72 in the manner shown in the flowchart of FIG. 9.

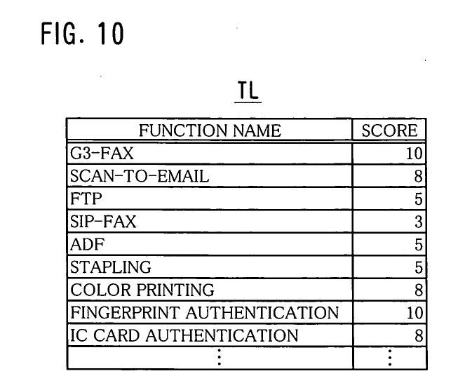

The function importance level table TL as shown in FIG. 10 is prepared in advance for each of the image forming apparatuses 1. The function importance level table TL defines a score (hereinafter referred to as a “importance level score”) indicating an importance level for each function.

For example, when being connected to the hub 41 via a LAN cable or the like and being turned on by a worker (#21 and #22 in FIG. 9), the image forming apparatus 1X obtains an IP address from the DHCP server 3 and sets the same for the image forming apparatus 1X itself (#23).

The image forming apparatus 1X searches for the other image forming apparatuses 1 already operating in the image processing system GSY (#24). Here, suppose that four of the image forming apparatuses 1A-1D are found.

When finding the image forming apparatuses 1A-1D (Yes in #25), the image forming apparatus 1X obtains the second apparatus attribute information 72 of the image forming apparatus 1A therefrom (#26). Then, the image forming apparatus 1X extracts functions that are indicated in both the first apparatus attribute information 71 and the second apparatus attribute information 72 thus obtained (#27). In other words, the image forming apparatus 1X extracts functions that are included in both the image forming apparatus 1X itself and the image forming apparatus 1A. The image forming apparatus 1X refers to the function importance level table TL shown in FIG. 10 to calculate a total score by adding importance level scores of the extracted functions (#28).

The processing from Step #26 through Step #28 is performed also on the image forming apparatuses 1B-LD, so that total scores are calculated respectively.

After the total score of each of the image forming apparatuses 1A-1D is calculated (Yes in #29), the image forming apparatus 1 having the total score equal to or more than a predetermined value is selected as an apparatus having the suitable setting information 8 for the image forming apparatus 1X (#30). Further, the image forming apparatus 1 having a higher total score is determined to be an apparatus having more suitable setting information 8. Then, the selection screen HG1 (see FIG. 7) is displayed in which the device names and others of the selected image forming apparatuses 1 are listed in descending order of total score (#31). The image forming apparatuses 1 may be ranked depending on the total score. The image forming apparatuses having a total score of 15 or more may be ranked “A”, and the image forming apparatuses 1 having a total score of 12-14 may be ranked “B” . . . for example.

The subsequent processing details are as described earlier in Step #9 through Step #11 of FIG. 8. More specifically, the second apparatus setting information 82 is obtained from the image forming apparatus 1 selected by the worker (#32 and #33). The entire or a part of the setting details indicated in the second apparatus setting information 82 thus obtained is copied, then to perform registration processing of the first apparatus setting information 81 for the image forming apparatus 1X itself (#34).

The importance level scores of the items shown in the function importance level table TL can be changed depending on the importance level of each function. If the biometrics function is important, for example, the importance level score of the same is preferably set to be higher than those of the other functions. Thereby, the apparatus 1 having the biometrics function can be high on the function importance level table TL.

Further, the installation location of the image forming apparatus 1 may be taken into consideration. For example, in Step #28, some points may be added especially, as the importance level scores, to the other image forming apparatus 1 that is installed on the same sector (division) as the image forming apparatus 1X.

### Alternatively, the other image forming apparatus 1 that is installed on the same sector as the image forming apparatus 1X can be high on the function importance level table TL.

In this embodiment, the image forming apparatus 1 presents a worker with the other image forming apparatuses 1 meeting a certain standard as candidates for the other image forming apparatus 1 having the suitable setting information 8. Then, the image forming apparatus 1 obtains the setting information 8 (the second apparatus setting information 82) from the other image forming apparatus 1 selected by the worker. After that, the image forming apparatus 1 performs processing of registering the setting information 8 (the first apparatus setting information 81) for the image forming apparatus 1 itself based on the second apparatus setting information 82. Instead, however, a configuration may be adopted in which all the registration processing can be performed automatically without presenting the candidates to the worker. In such a case, the image forming apparatus 1 preferably obtains the second apparatus setting information 82 from the other image forming apparatus 1 having a type name closest to (highly similar to) that of the image forming apparatus 1 itself. Alternatively, the second apparatus setting information 82 may be obtained from the other image forming apparatus 1 having the highest total score calculated in Step #28 shown in FIG. 9.

In this embodiment, the image forming apparatus 1 registers its own first apparatus setting information 81 based on the second apparatus setting information 82 obtained from one of the other image forming apparatuses 1. Instead, however, the registration processing may be performed based on the second apparatus setting information 82 obtained from a plurality of the other image forming apparatuses 1, as follows.

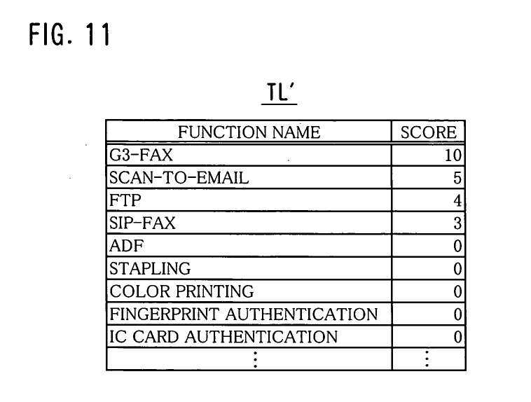

A function importance level table TL′ is prepared for each setting item such as an address book, user authentication, scanning, copying, network administration or power source control. As shown in FIG. 11, for example, in the function importance level table TL′ relating to the address book, an importance level score is given to each function required for designation at a destination, e.g., a G3-FAX function or a SCAN-TO-EMAIL function.

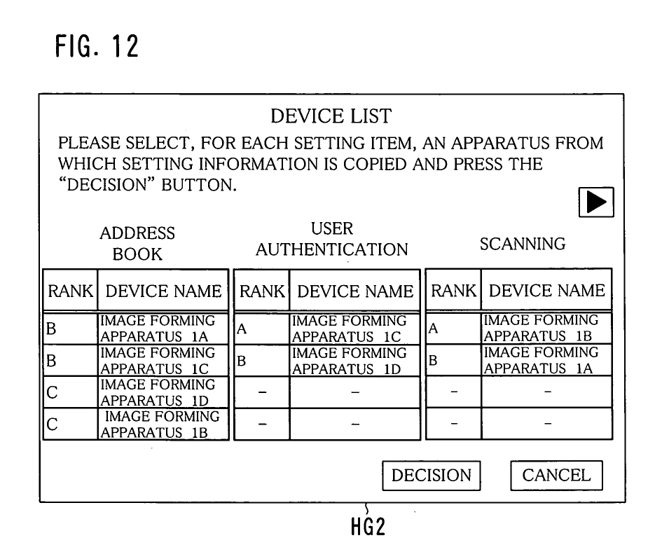

The image forming apparatus 1 determines the other image forming apparatus 1 having the suitable setting information 8 (the suitable second apparatus setting information 82) for each of the setting items based on the respective function importance level tables TL′. Then, the image forming apparatus 1 displays the selection screen HG2 as shown in FIG. 12 to present the same to a worker. Responding to this, the worker selects, for each of the setting items, the other image forming apparatus 1 from which the second apparatus setting information 82 should be obtained.

The image forming apparatus 1 obtains the second apparatus setting information 82 from the other image forming apparatus 1 selected by the worker to copy setting details for each of the setting items. Thereby, the image forming apparatus 1 registers the first apparatus setting information 81.

Instead of letting the worker select the other image forming apparatus 1, the image forming apparatus 1 determines and obtains the optimum second apparatus setting information 82 for each of the setting items to copy setting details for each of the setting items. Thereby, the image forming apparatus 1 registers the first apparatus setting information 81.

Thus, the selection of the second apparatus setting information 82 for each setting item can reliably prevent lack of setting details of the first apparatus setting information 81.

Each of the image forming apparatuses 1 may include a flag indicating whether or not its own setting information 8 may be provided to the other image forming apparatus 1. The image forming apparatus 1 may be adapted to provide its own setting information 8 if its own flag is ON, in response to a request from the other image forming apparatus 1. The image forming apparatus 1 may be adopted to deny the request if the flag is OFF. For example, the flag of the image forming apparatus 1 having the setting information 8 including important information on security is set to be OFF. Further, the flag of the image forming apparatus 1 having the setting information 8 including specific setting details is set to be OFF.

The present invention makes it possible to properly select setting information suitable for a new image processing apparatus from among setting information of the existing image processing apparatuses, so that the selected setting information becomes available for setting for the new image processing apparatus.

In the embodiments described above, the overall configuration of the image processing system GSY and the image forming apparatus 1, the configurations of various portions thereof, the details of processing, the details of setting, the processing order, the constitution of the tables and the like may be changed as needed, in accordance with the subject matter of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. An image processing apparatus performing processing relating to an image, the apparatus comprising:
a communications portion for communicating with a plurality of other image processing apparatuses via a communications line;
an attribute information obtaining portion for obtaining attribute information via the communications line, the attribute information indicating an attribute of each of the other image processing apparatuses;
a determination portion for determining, among setting information indicating setting details of each of the other image processing apparatuses, the setting information suitable for the image processing apparatus itself based on the attribute information obtained by the attribute information obtaining portion;
a setting information obtaining portion for obtaining the setting information that is determined to be suitable by the determination portion from the other image processing apparatus having the setting information via the communications line; and
a setting processing portion for using all or some of the setting details indicated in the setting information for setting of the image processing apparatus itself, the setting information being obtained by the setting information obtaining portion.

2. The image processing apparatus according to claim 1, wherein
the attribute information of the other image processing apparatus indicates a type of the other image processing apparatus, and
the determination portion determines that the setting information of the other image processing apparatus whose type is closest to a type of the image processing apparatus itself is suitable.

3. The image processing apparatus according to claim 1, wherein
the attribute information of the other image processing apparatus indicates a function included in the other image processing apparatus, and
the determination portion determines that the setting information of the other image processing apparatus having the function whose configuration is closest to a configuration of a function included in the image processing apparatus itself is suitable.

4. The image processing apparatus according to claim 1, further comprising
an offering processing portion for performing processing for presenting a worker with one or more pieces of the setting information determined to be suitable by the determination portion, the worker performing a task for the setting of the image processing apparatus itself,
wherein
the setting information obtaining portion obtains, among the setting information presented by the offering processing portion, the setting information selected by the worker.

5. The image processing apparatus according to claim 4, wherein
the attribute information of the other image processing apparatus indicates a type of the other image processing apparatus, and
when a degree of similarity between the type of the other image processing apparatus and a type of the image processing apparatus itself falls within a predetermined range, the determination portion determines that the setting information of the other image processing apparatus is suitable.

6. The image processing apparatus according to claim 4, wherein
the attribute information of the other image processing apparatus indicates a function included in the other image processing apparatus, and
when a degree of similarity between a configuration of the function included in the other image processing apparatus and a configuration of a function included in the image processing apparatus itself falls within a predetermined range, the determination portion determines that the setting information of the other image processing apparatus is suitable.

7. The image processing apparatus according to claim 1, wherein the determination portion determines the suitable setting information for each predetermined item.

8. A processing method regarding setting of an image processing apparatus having a function of communicating with a plurality of other image processing apparatuses via a communications line, the method letting the image processing apparatus perform the processing comprising:
obtaining attribute information indicating an attribute of each of the other image processing apparatuses via the communications line;
determining, among setting information indicating setting details of each of the other image processing apparatuses, the setting information suitable for the image processing apparatus itself based on the obtained attribute information;
obtaining the setting information that is determined to be suitable from the other image processing apparatus having the setting information via the communications line; and
using all or some of the setting details indicated in the obtained setting information for the setting of the image processing apparatus itself.

9. The processing method according to claim 8,
wherein
the attribute information of the other image processing apparatus indicates a type of the other image processing apparatus, and
the image processing apparatus is made to determine that the setting information of the other image processing apparatus whose type is closest to a type of the image processing apparatus itself is suitable.

10. The processing method according to claim 8,
wherein
the attribute information of the other image processing apparatus indicates a function included in the other image processing apparatus, and
the image processing apparatus is made to determine that the setting information of the other image processing apparatus having the function whose configuration is closest to a configuration of a function included in the image processing apparatus itself is suitable.

11. The processing method according to claim 8, the method letting the image processing apparatus perform the processing further comprising:
presenting a worker with one or more pieces of the setting information determined to be suitable, the worker performing a task for the setting of the image processing apparatus itself, and
obtaining the setting information selected by the worker among the presented setting information.

12. The processing method according to claim 11,
wherein
the attribute information of the other image processing apparatus indicates a type of the other image processing apparatus, and
when a degree of similarity between the type of the other image processing apparatus and a type of the image processing apparatus itself falls within a predetermined range, the image processing apparatus is made to determine that the setting information of the other image processing apparatus is suitable.

13. The processing method according to claim 11,
wherein
the attribute information of the other image processing apparatus indicates a function included in the other image processing apparatus, and
when a degree of similarity between a configuration of the function included in the other image processing apparatus and a configuration of a function included in the image processing apparatus itself falls within a predetermined range, the image processing apparatus is made to determine that the setting information of the other image processing apparatus is suitable.

14. The processing method according to claim 8, wherein the image processing apparatus is made to determine the suitable setting information for each predetermined item.

15. A computer-readable storage medium storing a computer program for use in an image processing apparatus having a function of communicating with a plurality of other image processing apparatuses via a communications line, the computer program letting the image processing apparatus perform the processing comprising:
obtaining attribute information indicating an attribute of each of the other image processing apparatuses via the communications line;
determining, among setting information indicating setting details of each of the other image processing apparatuses, the setting information suitable for the image processing apparatus itself based on the obtained attribute information;
obtaining the setting information that is determined to be suitable from the other image processing apparatus having the setting information via the communications line; and
using all or some of the setting details indicated in the obtained setting information for the setting of the image processing apparatus itself.
